(19) United States
(12) Patent Application Publication
(10) Pub. No.: US 2016/0108796 A1
(43) Pub. Date: Apr. 21, 2016

(54) THERMOSTAT

(71) Applicants: HYUNDAI MOTOR COMPANY, Seoul (KR); KIA MOTORS CORPORATION, Seoul (KR)

(72) Inventors: Jae Man CHO, Seoul (KR); Kwang Sik YANG, Gunpo-si (KR)

(21) Appl. No.: 14/709,345

(22) Filed: May 11, 2015

(30) Foreign Application Priority Data
Oct. 17, 2014 (KR) 10-2014-0141173

(51) Int. Cl. F01P 7/16; G05D 23/02

(52) U.S. Cl. CPC F01P 7/165; G05D 23/022

(57) ABSTRACT

A thermostat is fitted with a heat sensing portion caused to expand and move by heat transmitted from a coolant, and controlling a flow rate of the coolant flowing into a radiator or an engine by operation of the heat sensing portion. The thermostat includes a flow-changing wall mounted at a lower portion of the thermostat such that the flow-changing wall changes a flow direction of the coolant, towards a vicinity of the heat sensing portion. The flow-changing wall comprises a coupling poriton fixedly coupled to a lower portion of the heat sensing portion, and a skirt extending towards a lower portion of the coupling portion such that the skirt changes the flow direction of the coolant, towards the coupling portion.

### CROSS-REFERENCE TO RELATED APPLICATION

The present application claims priority of Korean Patent Application No. 10-2014-0141173 filed on Oct. 17, 2014, the entire contents of which application are incorporated herein by reference.

### BACKGROUND

(a) Field

This disclosure relates generally to a thermostat, and more particularly to a thermostat having improved temperature sensing performance by conversion of coolant flow direction.

(b) Description of Related Art

In general, a thermostat for a vehicle is mounted between an engine and a radiator, is automatically opened or closed depending on temperature changes of a coolant, and plays a role of maintaining appropriate temperatures of the coolant by controlling a flow rate of the coolant into an engine or a radiator.

Among thermostats for a vehicle, there are mechanical type thermostats in which a degree of expansion of a wax pellet varies depending on heat transmitted from a coolant, whereby force by the expansion is transferred to a piston. The piston brings about an opening/closing displacement of a valve. Electric type thermostats are devices in which an electric heater is installed inside each wax pellet, temperatures of the electric heater are controlled, and thereby an opening/closing displacement of each thermostat is controlled.

A heat sensing portion, in which a member such as a wax pellet that is responsive to temperature, is mounted, has to be disposed at a depth or a position representing a coolant temperature, in order to adequately control temperatures of a coolant. However, there are cases in which constraints such as the thermostat structure itself or a change in mounting position of a thermostat in coolant lines prevents adequate temperature sensing and control.

In addition, sometimes coolant never passes by the heat sensing portion.

FIG. 1 is a cross-sectional view of a mounting portion of a thermostat, showing a condition in which temperature sensing has deteriorated performance in a prior thermostat structure.

Referring to FIG. 1, an upper end of a thermostat 1 is connected to an outlet side of a radiator, and a bypass valve 30 is mounted at a lower end of the thermostat 1.

In general, abypass valve 30 increases coolant flow rate from an engine to a radiator or from a radiator to an engine by closing a bypass passage when thermostat 1 is opened by an increase of coolant temperature, and discharges coolant through the bypass passage into other devices or allows coolant to additionally flow in from other devices by opening the bypass passage, when the thermostat 1 is closed.

A heat sensing portion 10 of thermostat 1 is generally positioned to effectively contact coolant dicharged from an outlet of a radiator or engine, but thermostat 1 in FIG. 1 is positioned in reverse with respect to mounting directions in the above cases.

A detailed explanation will be omitted because mounting directions of a thermostat 1 in general, and means of valve operation are already known to a person skilled in the art.

The letter A represents an outlet side of a heater or another cooling system device, B depicts a bypass passage, and C an inlet side of an engine, in FIG. 1.

In addition, B can be closed or deleted when a bypass valve 30 is not mounted to thermostat 1.

When thermostat 1 is mounted in a way different from generally, or the position of thermostat 1 in the coolant lines is changed on account of a requirement of coolant lines design, a case in which coolant flows from A and B to C do not pass by a heat sensing portion 10, can be realized as shown in FIG. 1.

In other cases, temperature sensing performance can deteriorate because the heat sensing portion 10 is not immersed with sufficient depth in a coolant, even though coolant flow passes by a heat sensing portion 10 of thermostat 1.

When temperature sensing performance is not sufficient for the above-mentioned reasons, accurate control of coolant temperatures cannot be achieved, and thereby an engine can overheat.

As this can cause a serious problem for a cooling system, an improvement is badly needed.

The above information disclosed in this Background section is only for enhancement of understanding of the background of the invention and therefore it may contain information that does not form the prior art that is already known in this country to a person of ordinary skill in the art.

### SUMMARY

Various aspects of the present invention are directed to providing a thermostat, the heat sensing performance of which can be considerably improved without an excessive design change or a large increase in cost, even though performance would deteriorate due to thermostat structure or change in thermostat mounting position in coolant lines.

In various aspects of the present invention, a thermostat is fitted with a heat sensing portion caused to expand and move by heat transmitted from a coolant, and controlling a flow rate of the coolant flowing into a radiator or an engine by operation of the heat sensing portion,. Thethermostat includes a flow-changing wall mounted at a lower portion of the thermostat such that the flow-changing wall changes the flow direction of the coolant, towards a vicinity of the heat sensing portion. The flow-changing wall comprises a coupling poriton fixedly coupled to a lower portion of the heat sensing portion, and a skirt extending towards a lower portion of the coupling portion such that the skirt changes the flow direction of the coolan, towards the coupling portion.

The coupling portion may be of a hollow cylindrical shape, and the skirt may be formed such that a cross section perpendicular to a length direction of the skirt has the shape of a circular arc.

The flow-changing wall may be mounted such that an interior surface of the skirt is perpendicular or substantially perpendicular to the direction of flow of coolant.

The heat sensing portion may have a wax pellet mounted therein.

The thermostat may further include a bypass valve mounted at a lower end of the thermostat such that the bypass valve blocks a bypass passage when the thermostat is opened. The flow-changing wall may be formed such that flow of coolant through the bypass valve is guided by the skirt, and the flow direction of the coolant is changed towards the heat sensing poriton by the interior surface of the coupling portion.

### BRIEF DESCRIPTION OF THE DRAWINGS

FIG. 1 is a cross-sectional view of a mounting portion of a thermostat, showing a condition in which temperature sensing performance deteriorates when using a prior thermostat structure.

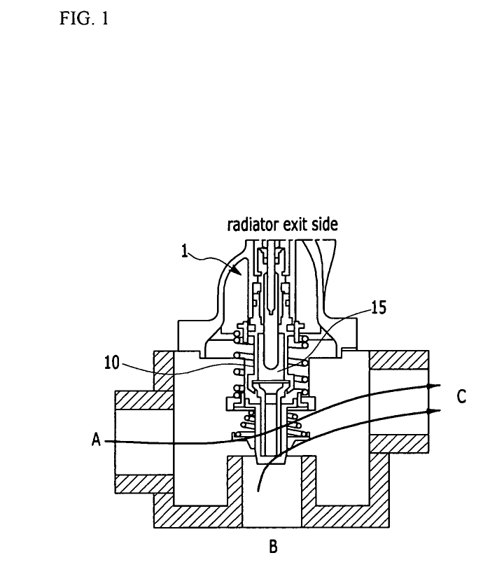

FIG. 2 contains a cross-sectional view and an enlarged view showing the structure and operational principle of an exemplary thermostat according to an embodiment of the present invention.

FIG. 3 is a perspective view of an exemplary flow-changing wall according to an embodiment of the present invention.

FIG. 4 is a top plan view of an exemplary flow-changing wall according to an embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In addition, unless explicitly described to the contrary, the word “comprise” and variations such as “comprises” or “comprising” will be understood to imply the inclusion of stated elements but not the exclusion of any other elements and the name of a component doesn't set limits to the function of the component concerned.

General structure of a thermostat is well known to a person skilled in the art, a thermostat can be classified into a mechanical type and an electric type, and, hereinafter, exemplary embodiments of the present invention will be concretely explained with structures of a mechanical type of thermostats as a center.

A detailed explanation will be omitted on general mounting directions and operation methods of valves of thermostats, because they are known to a person skilled in the art.

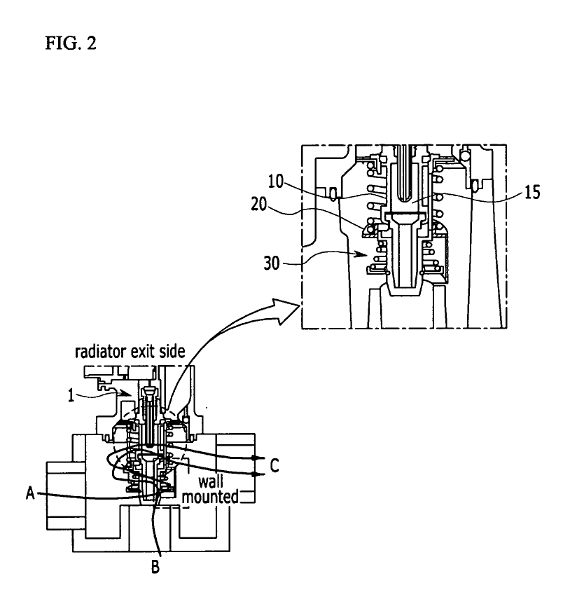

FIG. 2 contains a cross-sectional view and an enlarged view showing a structure and the operational principle of an exemplary thermostat according to an embodiment of the present invention.

Referring to FIG. 2, an exemplary thermostat according to an embodiment of the present invention has a heat sensing portion 10 caused to expand and move by heat transferred from a coolant, mounted at a lower portion of the thermostat, which may control a flow rate of coolant flowing towards a radiator or an engine.

An image in which a wax pellet 15 is mounted inside the heat sensing portion 10 is illustrated in FIG. 2.

An exemplary thermostat 1 according to an embodiment of the present invention further includes a flow-changing wall 20 mounted at a lower portion of the thermostat 1 such that the flow-changing wall changes the flow direction of coolant towards a vicinity of the heat sensing portion 10.

The flow-changing wall 20 may comprise a coupling poriton 21 fixedly coupled to a lower portion of the heat sensing portion 10, and a skirt 22 extending towards a lower portion of the coupling portion 21 such that the skirt 22 changes the flow direction of the coolant, towards the coupling portion 21.

Still referring to FIG. 2, coolant flow from A to C and from B to C are changed by the skirt 22, towards the coupling portion 21, that is, an upper portion of the flow-changing wall 20.

This is because the skirt 22 has a shape in which the skirt 22 blocks or guides coolant flow, and a passage is opened towards the coupling portion 21, simultaneously.

Accordingly, as shown in FIG. 2, two coolant flows are guided towards the coupling portion 21 of the flow-changing wall 20, and thereby can effectively make contact with and pass by the heat sensing portion 10 disposed at a upper side of the coupling portion 21 in height direction.

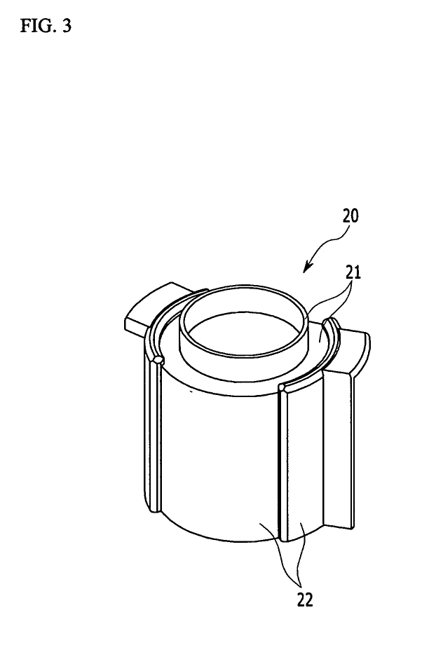

FIG. 3 is a perspective view of an exemplary flow-changing wall according to an embodiment of the present invention.

Referring to FIG. 3, the coupling portion 21 may be formed to have a hollow cylindrical shape, and the skirt 22 may have a section perpendicular to a length direction thereof such that the section has the shape of a circular arc.

In addition, the flow-changing wall 20 may be mounted such that an interior surface of the skirt 22 is perpendicular or substantially perpendicular to flow direction of the coolant.

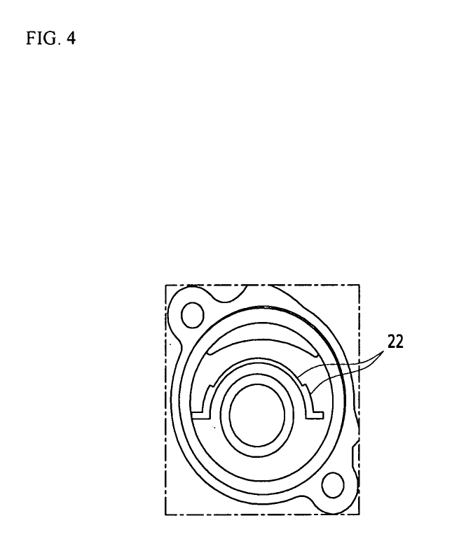

FIG. 4 is a top plan view of an exemplary flow-changing wall according to an embodiment of the present invention.

Referring to FIG. 4, the shape of the skirt 22 can be understood more clearly.

The skirt 22, the section of which is a circular arc in shape, may block or guide coolant flow.

When coolant flow is guided, coolant flowing through the skirt 22 runs into an interior surface of the coupling portion 21 of the flow-changing wall 20, and flows towards an outside of the coupling portion 21 through an opened portion of the circular arc.

When skirt 22 guides a coolant flow as mentioned above, an exemplary thermostat 1 according to an embodiment of the present invention may further include a bypass valve 30 mounted at a lower end of the thermostat 1 such that the bypass valve 30 blocks bypass passage B when the thermostat is opened.

In this case, the flow-changing wall 20 is formed such that coolant flow passing through the bypass valve 30 is guided by the skirt 22 and flow direction is changed by the interior surface of the coupling portion 21, towards the heat sensing portion 10.

As explained in detail, even though heat sensing performance of a thermostat deteriorates as a result of diverse limitations, heat sensing performance can be considerably improved without excessive design change or large cost, according to the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A thermostat fitted with a heat sensing portion caused to expand and move by heat transmitted from a coolant, and controlling a flow rate of the coolant flowing into a radiator or an engine by operation of the heat sensing portion,
wherein the thermostat further includes
a flow-changing wall mounted at a lower portion of the thermostat such that the flow-changing wall changes a flow direction of the coolant, towards a vicinity of the heat sensing portion, and
wherein the flow-changing wall comprises
a coupling portion fixedly coupled to a lower portion of the heat sensing portion, and
a skirt extending towards a lower portion of the coupling portion such that the skirt changes the flow direction of the coolant, towards the coupling portion.

2. The thermostat of claim 1,
wherein the coupling portion has a hollow cylindrical shape, and
the skirt is formed such that a cross section perpendicular to a length direction of the skirt has a shape of a circular arc.

3. The thermostat of claim 2,
wherein the flow-changing wall is mounted such that an interior surface of the skirt is perpendicular or substantially perpendicular to a flow direction of the coolant.

4. The thermostat of claim 1,
wherein the heat sensing portion has a wax pellet mounted therein.

5. The thermostat of claim 1, further including
a bypass valve mounted at a lower end of the thermostat such that the bypass valve blocks a bypass passage when the thermostat is opened,
wherein the flow-changing wall is configured such that
a flow of the coolant passing through the bypass valve is guided by the skirt and a flow direction of the coolant is changed towards the heat sensing poriton by an interior surface of the coupling portion.
